(19) United States
(12) Patent Application Publication
(10) Pub. No.: US 2008/0102393 A1
(43) Pub. Date: May 1, 2008

(54) TONER, METHOD OF SUPPLYING THE SAME AND PROCESS CARTRIDGE

(76) Inventor: Kumi Hasegawa, Numazu-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/931,590

(22) Filed: Oct. 31, 2007

(30) Foreign Application Priority Data
Nov. 1, 2006 (JP) 2006-298194

(51) Int. Cl. G03G 9/087; G03G 15/08

(52) U.S. Cl. 430/109.3; 399/258

(57) ABSTRACT

A toner including a colorant, a binder resin, and a releasing agent, wherein the toner has a number average particle diameter measured by a Coulter Counter method of from 3.5 to 6.5 μm and a peak top molecular weight (MPT) of from 2,500 to 4,800, the binder resin contains a crystalline polyester resin and a hybrid resin component containing a styrene-acryl resin and a polyester resin, a content A of the crystalline polyester resin and a content B of the hybrid resin component satisfy the following relationship (1): ½ A≦B≦3 A, and the crystalline polyester resin has a structure represented by a following chemical formula (A) having at least 60 mol % of whole ester bonds in the binder resin: —OOC—R—COO—(CH₂)ₙ—, (A); a method for supplying the toner and a process cartridge useful in the method.

### BACKGROUND OF THE INVENTION

1. Field of the Invention

The present invention relates to a toner for use in development of latent electrostatic images formed by electrophotography, electrostatic recording methods, electrostatic printing methods, etc. and also relates to a method of supplying toner powder from a flexible toner container to a development portion.

2. Discussion of the Background

In recent years, fixing toner at a low temperature has been a great issue in image formation and various kinds of studies and developments have been made to solve this problem. For example, unexamined published Japanese patent application No. (hereinafter referred to as JOP) 2001-222138 describes a technology in which a toner binder resin including a crystalline polyester is used to have a great impact on improvement on the low temperature fixability of toner in comparison with a typical non-crystalline polyester. However, there is a problem when both resins are used in combination. That is, the crystalline polyester resins cannot maintain a high crystalline property by, for example, an ester exchange reaction when both resins are melted and kneaded because both resins are similar to each other in structure. Therefore, the preservability of this toner tends to deteriorate.

JOP H11-249339 and 2003-302791 describe a toner binder resin in which a crystalline polyester having a sebacic acid or adipic acid as its carboxyl acid component is used in combination with a styrene-acryl resin. These toners have a good low temperature fixability and preservability and at the same time, further improvement is demanded.

In addition, JOP 2004-191516 describes a toner having a particular crystalline polyester resin and an amorphous hybrid resin to provide a good combination of preservability and low temperature fixability. However, this toner causes fogging and non-uniform image density due to poor compatibility between the crystalline polyester and the pigment.

Furthermore, JOP 2005-338814 describes a technology in which a particular polyester resin contributes to improvement on low temperature fixability. However, the preservability is not discussed therein.

On the other hand, to deal with the environment issue, there is proposed a toner container made of a flexible material and that is foldable to reduce the volume thereof for more convenient collection. These type containers have a large volume contraction ratio and can be manufactured inexpensively. Furthermore, toner can be automatically supplied by air, so as not to scatter in the air after the toner container is attached to the main body of an image forming apparatus. However, since it is difficult to form spiral grooves in a container for supplying powdered toner and incorporate a device such as an agitator in a container, the following problems arise:
(1) The amount of toner supplied it not stable.
(2) While preserved, toner tends to pack in a container so that the toner cannot be supplied.
(3) The amount of residual toner powder is large.

### SUMMARY OF THE INVENTION

Because of these reasons, the present inventor recognizes that a need exists for a toner that has a good low temperature fixability and preservability and a small particle diameter and produces a uniform image without fogging or uneven density, and for a method of supplying toner in which toner is automatically supplied from a toner container to a development portion, where the toner container is made of a flexible material and that is foldable to reduce the volume thereof for more convenient collection. By this method, the amount of toner powder is stably supplied, the toner powder is prevented from packing while preserved in the toner container and the amount of residual toner powder therein is reduced.

Accordingly, an object of the present invention is to provide a toner that has a good low temperature fixability and preservability and a small particle diameter and produces a uniform image without fogging or uneven image density.

Another object of the present invention is to provide a method of supplying toner in which toner is supplied from a toner container to a development portion, where the toner container is made of a flexible material and foldable to reduce the volume thereof for more convenient collection. Furthermore, by this method, the amount of toner powder is stably supplied, the toner powder is prevented from packing while preserved in the toner container and the amount of residual toner powder therein is reduced.

Briefly these objects and other objects of the present invention as hereinafter described will become more readily apparent and can be attained, either individually or in combinations thereof, by a toner including a colorant, a binder resin and a releasing agent, wherein the toner has a number average particle diameter measured by a Coulter Counter method of from 3.5 to 6.5 μm and a peak top molecular weight (MPT) of from 2,500 to 4,800, the binder resin contains a crystalline polyester resin and a hybrid resin component containing a styrene-acryl resin and a polyester resin, the content A of the crystalline polyester resin and the content B of the hybrid resin component satisfy the following relationship (1): ½ A≦B≦3 A, and the crystalline polyester resin has a structure represented by chemical formula (A) with at least 60 mol % of whole ester bonds in the binder resin: —OOC—R—COO—(CH₂)ₙ—, (A). In the chemical formula (A), R represents a straight chain unsaturated aliphatic group having 2 to 20 carbon atoms and n represents an integer of from 2 to 20;

along with a method for supplying the toner to a development portion of an electrophotographic recording medium or apparatus, and a process cartridge for use in the method.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic diagram illustrating an example of the method of supplying toner of the present invention;

FIG. 2 is a schematic diagram illustrating an example of a container of toner powder;

FIG. 3 is a diagram illustrating an example of a container of toner powder when the container is reduced in volume;

FIG. 4 is a schematic diagram illustrating a toner supplying device; and

FIG. 5 is a diagram illustrating an example print for use in the evaluation criteria of characteristic sharpness.

These and other objects, features and advantages of the present invention will become apparent upon consideration of the following description of the preferred embodiments of the present invention taken in conjunction with the accompanying drawings.

### DETAILED DESCRIPTION OF THE INVENTION

The toner, etc. of the present invention will be described below in detail with reference to several embodiments and accompanying drawings.

The present invention relates to a toner comprising a colorant, a binder resin and a releasing agent. The toner has a number average particle diameter measured by a Coulter Counter method of from 3.5 to 6.5 μm and a peak top molecular weight (MPT) of from 2,500 to 4,800, the binder resin contains a crystalline polyester resin and a hybrid resin component containing a styrene-acryl resin and a polyester resin, the content A of the crystalline polyester resin and the content B of the hybrid resin component satisfy the following relationship (1): ½ A≦B≦3 A, and the crystalline polyester resin has a structure represented by chemical formula (A) with at least 60 mol % of whole ester bonds in the binder resin: —OOC—R—COO—(CH₂)ₙ—, (A). In the chemical formula (A), R represents a straight chain unsaturated aliphatic group having 2 to 20 carbon atoms and n represents an integer of from 2 to 20.

It is preferred in the present invention toner, that the binder resin further includes a non-crystalline polyester resin.

It is still further preferred in the present invention toner, that the non-crystalline polyester resin has a softening point of from 120 to 160° C.

It is still further preferred in the present invention toner, that the non-crystal polyester resin satisfies the following relationship (2):

0.008≦G′(0.01 Hz)/G′(1 Hz)≦0.90 (2)

wherein G′ (1 Hz) and G′ (0.01 Hz) represents a storage elastic modulus of the non-crystalline polyester resin at a frequency of 1 Hz and 0.01 Hz, respectively, by a frequency sweep method using a rheometer.

It is still further preferred that at least one compound selected from the group consisting of an inorganic tin(II)compound, a tin(II)carbonate compound having a carboxyl acid group having 2 to 28 carbon atoms and a dialkoxy tin(II)compound having an alkoxy group having 2 to 28 carbon atoms is used as a catalyst when the crystalline polyester, the hybrid resin and/or the non-crystalline polyester resin are manufactured.

It is still further preferred that the particles distribution variance coefficient (standard deviation of number of particles distribution/number average particle diameter×100) of the toner measured by the COULTER COUNTER method is from 22.0 to 35.0 and the present invention toner contains toner particles having a particle diameter of from 4.0 to 8.0 μm in an amount of from 40 to 59% by number.

As another aspect of the present invention, a method of supplying toner is provided which includes transferring a fluid mixture of toner powder accommodated in a toner container, and air to a development portion of an electrophotographic apparatus or recording medium using a pumping device by which backflow of the fluid mixture is prevented.

It is preferred that an air influx device for flowing air in the toner container is provided.

It is still further preferred that the toner container includes a flexible member and has a volume contraction ratio of not less than 60% in volume.

It is still further preferred that, in the method mentioned above, the pumping device is provided such that backflow of the liquid mixture of the toner powder and the air is prevented by rotating a fixed hollow elastic member and a spirally curved rigid axis contacting an inner wall of the fixed hollow elastic member.

As another aspect of the present invention, a process cartridge is provided which includes an image bearing member, a development device and at least one of a charge device and a cleaning device, wherein the process cartridge is detachably attached to the main body of an image forming apparatus and toner used in the development device is the toner.

The toner of the present invention has a number average particle diameter of from 3.5 to 6.5 μm. In this range, the toner particles contained in toner are sufficiently small to develop minute latent dots. Therefore, the toner is excellent in dot reproducibility and since the energy required to melt one toner particle is small, the low temperature fixability is good. A toner that has an excessively small toner particle diameter causes phenomena such that the productivity of toner and blade cleaning property deteriorate. By contrast, when the toner has an excessively large particle diameter, the low temperature fixability deteriorates because the energy required to melt one toner particle is large, and it is difficult to reduce scattering of characters and lines.

In the toner of the present invention, the polyester resin having a crystalline property can be melted at the glass transition temperature and the melting viscosity of the resin drastically drops from the solid state thereof. This resin has a fixing ability that is not obtained by an amorphous polyester resin.

By contrast, in the mixing and kneading process of manufacturing a toner, the melting viscosity of such a crystalline polyester resin drastically drops by heat generated during the mixing and kneading process. Therefore, mechanical dispersion force or shearing force tends not to apply to the crystalline polyester resin. Thus, carbon black and/or a pigment added as a colorant and/or a charge control agent tend not to be dispersed in the crystalline polyester resin and are selectively dispersed in non-crystalline resin.

Thus, when such a crystalline polyester has a portion that is exposed to the pulverization interface of the toner and the portion is large, the content of a colorant or a charge control agent is not constant, which causes non-uniform charging, resulting in image fogging or non-uniform image density. This phenomenon is significant in the case of a toner having a small particle diameter, for example, 6.0 μm (the number average particle diameter).

In the case of a toner having an excessively small particle diameter, the dispersion property of the crystalline polyester and other materials is desired to be improved. However, when the dispersion property is improved by increasing shearing during mixing and kneading, the crystalline property is destroyed. That is, the target function is not obtained. In addition, by increasing shearing, shearing property is also improved. As a result, the thermal characteristic of the resultant toner is extremely degraded and sufficient anti-hot offset property is not obtained.

To prevent image fogging or uneven image density caused by bad dispersion property of a crystalline polyester resin and achieve the low temperature fixability thereof even in the case of a toner having a small particle diameter (i.e., the number average particle diameter thereof is not greater than 6.0 μm), it is preferred that the toner contains a crystalline polyester and a hybrid resin component containing a styrene acryl resin and a polyester resin as a binder resin, the peak top molecular weight (MPT) of the toner is from 2,500 to 4,800, and the content A of the crystalline polyester resin and the content B of the hybrid resin component satisfy the following relationship (1):

½A≦B≦3A (1)

Since a styrene acryl resin has a different structure from a crystalline polyester resin, the crystalline polyester resin maintains its crystalline property during melting and kneading. Therefore, the crystalline polyester resin is finely dispersed without degrading the structures and/or properties of the crystalline polyester so that these resins can be used in combination while maintaining the advantages of both resins.

When a styrene acryl resin is used alone, transparency is not sufficiently obtained especially for a color toner, and the low temperature fixability thereof is not good. To obtain a sufficient fixing temperature range, a hybrid resin component containing a styrene acryl resin and a polyester resin is preferably contained in a toner. With regard to the content thereof, the relationship (1) is preferably satisfied. That is, in the relationship (1), when B is less than ½ A, the dispersion property of the crystalline polyester resin is not sufficient so that the dispersion particle diameter increases. When this polyester resin exposes to the surface of toner, image fogging or uneven image density occurs due to non-uniformity in dispersion composition with other materials. When B is greater than 3 A, there is an adverse impact on the low temperature fixability.

Furthermore, when toner has a peak top molecular weight (MPT) from 2,500 to 4,800, it is not the crystalline polyester resin but the other binder resins, including the hybrid resin, that form the pulverization interface of the toner. That is, the crystalline polyester resin is contained inside the toner particle and the dispersion composition on the surface is uniform. When the toner has an excessively small peak top molecular weight (MPT), the glass transition point tends to lower and consequently the preservability easily deteriorates. When the toner has an excessively large peak top molecule weight (MPT), the pulverization property tends to deteriorate. Therefore, the crystalline polyester resin and/or wax tend to expose to the pulverization interface instead of the other binder resin including the hybrid resin. This causes image fogging and uneven image density because the agglomeration property deteriorates and the dispersion composition is non-uniform. To adjust the peak top molecular weight (MPT) of a toner to be from 2,500 to 4,800, the molecular shearing conditions during mixing and kneading are controlled.

Furthermore, to enlarge the range of the fixable temperature of a toner, it is preferred to contain a non-crystalline polyester resin having a softening point of from 120 to 160° C. as a third binder resin. The third binder resin can improve anti-hot offset property while maintaining a good low temperature fixing. When the softening point is too low, anti-hot offset property may deteriorate. When the softening point is too high, dispersion is made difficult because the toner tends to be highly elastic and thus the shearing force increases. The low temperature fixing property also tends to deteriorate.

When measuring the softening point, for example, a high elevated flow tester CF-500 manufactured by Shimadzu Corporation can be used. The softening point is measured as a temperature when a 1 cm³ sample material is melted and flows under the following conditions and the stroke of the plunger is ½ of the amount of the stroke change from the start of flowing to the end of flowing can be used:

### Load: 10 Kg/cm²

Temperature rising speed: 3.0° C./min.
Die diameter: 1 mm

It is preferred that the ratio of the storage elastic moduli G's of this non-crystalline polyester resin at a frequency of 1 Hz and 0.01 Hz by a frequency sweep method using a rheometer satisfies the following relationship (2):

0.008≦G′(0.01 Hz)/G′(1 Hz)≦0.90 (2)

and more preferably

0.01≦G′(0.01 Hz)/G′(1 Hz)≦0.80 (2)′

In the rubber range in polymer rheology characteristics, the behavior of a melt polymer changes according to the transformation speed. That is, the behavior of a melt polymer in the range of a high frequency is like that of a glassy solid having a high elastic modulus and is not dependent on the molecular weight of the polymer but greatly on the structure of the monomer of the polymer. By contrast, in the case of slow transformation (i.e., transformation at a low frequency), a melt polymer behaves like a viscous fluid. That is, in the range of low frequency transformation, the behavior of a melt polymer is highly dependent on the entire structure of the molecule, for example, molecular weight, molecular weight distribution and long chain branch structure. Therefore, the difference of the structure of a polymer, i.e., a resin, can be clearly detected in a range of low frequency transformation.

When the relationship (2) is satisfied, it means that a clear flat area appears from a rubber area to a fluid area and a polymer functions as a cross-linking point of rubber. Since a non-crystalline resin having a cross-linking structure satisfying the relationship (2) is used so that the torque during mixing and kneading is large, the dispersion property of the other materials, the crystalline polyester resin and wax increases and these can be contained inside of the toner. Therefore, the anti-hot offset property thereof is improved while the low temperature fixability of a crystalline polyester resin is maintained.

When the ratio of G′ (0.01 Hz) to G′ (1 Hz) is too small, the resin tends to be hard so that the load applied during mixing and kneading is large. Furthermore, the pulverization property tends to deteriorate, which leads to an increase in pulverization pressure. Therefore, wax easily exposes to the pulverization interface of the toner, resulting in deterioration of the agglomeration property and an occurrence of spent toner. When the ratio of G′ (0.01 Hz) to G′ (1 Hz) is too large, the non-crystalline resin tends to flow at a high temperature, resulting in insufficient anti-hot offset property.

The rheology characteristics of the present invention are measured by the following method.

The device for use in measurement is a viscoelastic measuring device (rheometer) RDA-II type (manufactured by Rheometrics Inc., Piscataway, N.J.).

Measuring jig: Parallel plate having a diameter of 7.9 mm
Measured sample: Sample material formed by molding heated and melted toner or binder resin into a cylinder having a diameter of about 8 mm and a height of from 2 to 5 mm
Measuring frequency: from 0.01 to 1 Hz.
Measuring temperature: 130° C.
Setting of measuring distortion: Initial value is set to be 0.1% and measured in automatic measuring mode:
Elongation compensation of sample material: Adjusted by automatic measuring mode.

To obtain a resin having a composition uniformity, it is also preferred that at least one compound selected from the group consisting of an inorganic tin(II)compound, a tin(II)carbonate compound having a carboxyl acid group having 2 to 28 carbon atoms and a dialkoxy tin(II)compound having an alkoxy group having 2 to 28 carbon atoms is used as a catalyst when the crystalline polyester, the hybrid resin and/or the non-crystalline polyester resin are manufactured.

Specific examples of such inorganic tin(II)compounds include, but are not limited to, a compound having a Sn—O linkage, a compound having a Sn—X (X represents a halogen atom) linkage, and a compound having a Sn—O linkage (tin(II)carbonate or dialkoxy tin(II)compound).

Specific examples of the compounds having Sn—O linkage include, but are not limited to, tin(II)carbonates having 2 to 28 carbon atoms, for example, tin(II)octylate, tin(II)oxalate, tin(II)diacetate, tin(II)dioctanoate, tin(II)dilaurylic acid, tin(II)distearate and tin(II)dioleate; dialkoxy tin compounds having 2 to 28 carbon atoms, for example, dioctyloxy tin(II)compounds, dilauryloxy tin(II)compounds, distearoxy tin(II)compounds, and dioleiloxy tin(II)compounds; tin(II)oxides; and tin(II)sulfonate. Specific examples of the compounds having Sn—X (X represents a halogen atom) linkage include, but are not limited to, a halogenated tin(II)compound derived from, for example, tin(II)chlorinate or tin(II)oxalate. Among these, in terms of the charge rising effect and catalyst power, aliphatic acid tin(II)compounds represented by (R₁COO)₂Sn (R₁ represents an alkyl group or alkenyl group having 5 to 19 carbon atoms) dialkoxy tin(II)compounds represented by (R₂O)₂Sn (R₂ represents an alkyl group or alkenyl group having 6 to 20 carbon atoms) and tin(II)oxide represented by SnO are preferred. Aliphatic acid tin(II)compounds represented by (R₁COO)₂Sn and tin(II)oxide are more preferred and tin(II)octylate, tin(II)dioctonate, tin(II)distearate and tin(II)oxides are particularly preferred.

The polyester resin composition for use in the present invention containing a polyester and a catalyst for use in manufacturing the polyester can be used as a binder resin for the present toner. The polyester can be manufactured by polycondensing a dialcohol (or polyol) and a di-carboxylic acid (or polycarboxylic acid) under the presence of the catalyst at a temperature range from 180 to 250° C. in an inert gas atmosphere with a reduced pressure.

The content of the inorganic tin(II)compound when manufacturing the polyester is preferably from 0.001 to 5 parts by weight and more preferably from 0.05 to 2 parts by weight based on 100 parts of the material monomer of the polyester. The content of the inorganic tin(II)compound in the polyester resin composition for use in the present invention manufactured by using the inorganic tin(II)compound as a catalyst is preferably from 0.001 to 5 parts by weight and more preferably from 0.05 to 2 parts by weight based on 100 parts by weight of the polyester resin.

Furthermore, to have a good combination of image quality and low temperature fixability, it is preferred that toner has a number average particle diameter of from 3.5 to 6.5 μm, and a variation coefficient (standard deviation of number distribution/number average particle diameter) of number distribution of from 22.0 to 35.0 and contains toner particles having a particle diameter of from 4.0 to 8.0 μm in an amount of from 40 to 59% by number.

When the number average particle diameter of toner is too small, the cleaning property may deteriorate and thus image fogging tends to occur. When the number average particle diameter is too large, sharpness of characters tends to deteriorate.

When the number average particle diameter is of from 3.5 to 6.5 μm and the variation coefficient (standard deviation of number distribution/number average particle diameter) of number distribution of toner is in the range mentioned above (i.e., from 22.0 to 35.0), the variation of toner fluidity and chargeability is small even when mixed with recycled toner in a recycling system. Therefore, images do not deteriorate. When the variation coefficient is too small, the distribution tends to be sharp so that the quality of initially obtained images is good but when the initial toner is mixed with recycled toner, the distribution of the initial toner and the distribution of the recycled toner are completely separate. In this case, due to the selective development characteristics during development, the initial toner is preferentially used for development, and the recycled toner is continuously accumulated in the development portion for a long time without being used for development and causes spent carrier or agglomeration of the developing agent. When the variation coefficient is too large, since the distribution is wide, a toner having a particular distribution is selected for development and the same drawback is caused by the same reason described above. When the variation coefficient is in the range of from 22.0 to 35.0, such preferential development is reduced even when mixed with recycled toner is mixed and the recycled toner is consumed so that the drawback mentioned above does not occur.

Toner having a particle diameter of from 4.0 to 8.0 μm is advantageous in the particle size distribution in terms of fixability.

When the particle diameter is too small, the toner is easily trapped between concavo-convex portions of a recording medium so that the nip is not applied to such trapped toner, resulting in bad fixing. In addition, toner that has an excessively small particle diameter has a high thermal conductivity. Therefore, such toner tends to be crushed during fixing, resulting in deterioration of the degree of granularity of images.

When the particle diameter is too large, the thermal conductivity tends to deteriorate, which is disadvantageous in light of fixability.

Toner that has a particle diameter of from 4.0 to 8.0 μm has a suitable thermal conductivity and good fixability. In addition, such toner is not completely crushed during fixing and thus the granularity level of an image is improved.

Toner having a particle diameter in this range is preferred to be contained in an amount of from 40 to 59% by number. When the amount is too large, the particle size distribution is sharp and the problem of the selective development property arises when the toner is mixed with recycled toner. When the amount is too small, the granularity of images tends to deteriorate. To improve the granularity furthermore, it is preferred to have toner having a particle diameter of from 4.0 to 5.0 μm in an amount of from 15 to 35% by number among toner having a particle diameter of from 4.0 to 8.0 μm. Since the toner having this particle diameter is thinly and uniformly fixed on an image, the image density is high with a small amount of the toner. When this ratio is too low, this effect may not be sufficient. When the ratio is too high, the initial toner is separated from recycled toner in light of distribution so that the selective development property during development causes a problem.

The toner of the present invention contains a crystalline polyester resin therein, does not agglomerate even when the toner has a small particle diameter as described above and obtains good fluidity.

The detection sensitivity significantly varies depending on the measuring device, especially in the range of from 2.0 to 5.0 μm. In the present invention, a Coulter Counter method is preferably used. A specific example of the device used in the Coulter Counter Method includes Coulter Counter TA-II type (manufactured by Beckman Coulter Inc.). Below is a description of the measuring method.

(1) Add 0.1 to 5 ml of a surface active agent (preferably a salt of an alkyl benzene sulfide) as a dispersing agent to 100 to 150 ml of an electrolytic aqueous solution. The electrolytic aqueous solution is an about 1% NaCl aqueous solution prepared by using primary NaCl (e.g., ISOTON-II®, manufactured by Beckman Coulter Inc.).

(2) Add 2 to 20 mg of a measuring sample to the electrolytic aqueous solution.

(3) The electrolytic aqueous solution in which the measuring sample is suspended is subject to a dispersion treatment for 1 to 3 minutes with a supersonic disperser.

(4) Measure the volume and the number of toner particles or toner with the aperture set to 100 μm for the measuring device mentioned above to calculate the volume distribution and the number distribution.

The volume average particle diameter (Dv) and the number average particle diameter (Dp) can be obtained from the obtained distributions.

The whole range is a particle diameter of from 2.00 to not greater than 40.30 μm and the number of the channels is 13. These channels are: from 2.00 to not greater than 2.52 μm; from 2.52 to not greater than 3.17 μm; from 3.17 to not greater than 4.00 μm; from 4.00 to not greater than 5.04 μm; from 5.04 to not greater than 6.35 μm; from 6.35 to not greater than 8.00 μm; from 8.00 to not greater than 10.08 μm; from 10.08 to not greater than 12.70 μm; from 12.70 to not greater than 16.00 μm, from 16.00 to not greater than 20.20 μm; from 20.20 to not greater than 25.40 μm; from 25.40 to not greater than 32.00 μm; and from 32.00 to not greater than 40.30 μm.

The toner for use in the present invention has a good low temperature fixability and a small particle diameter with excellent fluidity without toner agglomeration. Therefore, when a pump is used as a toner supplying device connected with a flexible toner container configured so as not to back-flow a fluid mixture of toner powder and air, the flexible toner container is automatically reduced in volume. It is found that, as the form around the container changes, the toner is unstiffened so that the amount of the residual toner is reduced for effective use.

In addition, it is found that when a nozzle, etc. is provided in a toner container to blow off, diffuse and pass air through a toner powder layer, toner fluidity is promoted and therefore, the toner is stably supplied and the amount of toner remaining in the toner container can be reduced even when a toner supply device, for example, an agitator, is not provided in the toner container as in the present invention.

A specific example of a toner powder supplying method from a toner container that can be used in the present invention is described below.

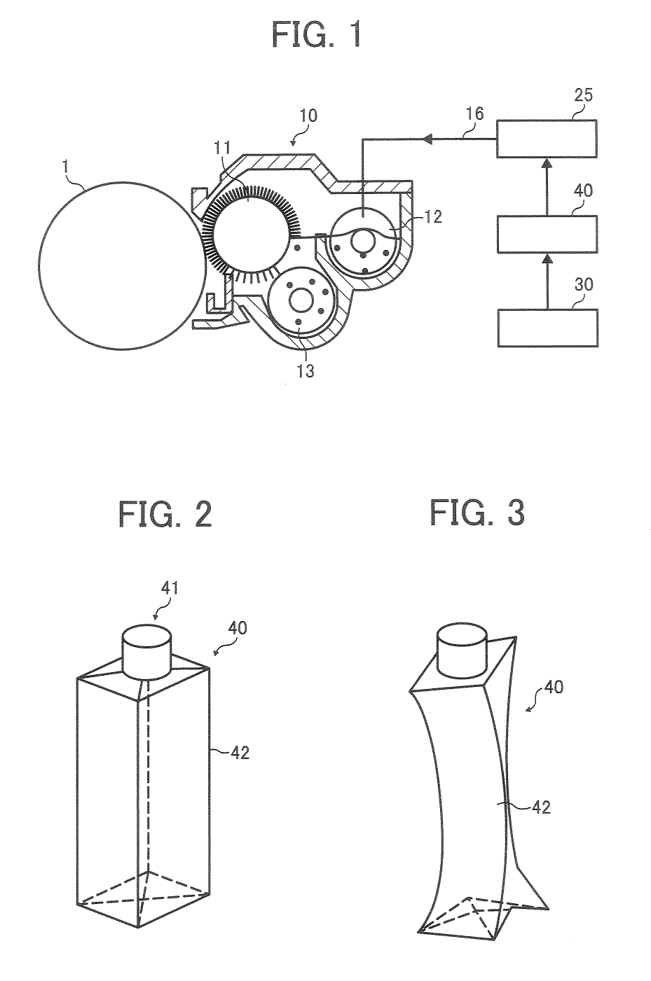

In FIG. 1, air is sent to a toner container 40 by an air influx device 30. The air is blown off into the toner container 40. The blown-off air passes and diffuses through a toner layer and promotes fluidity of the toner. Therefore, the occurrence of toner cross-linking phenomena can be prevented and the toner supply is secured.

In addition to the air supply, a suitable vibration or impact to the toner container is effective to stably suck and transfer toner having an extremely bad fluidity. That is, toner cross-linking is prevented and toner is securely transferred to a toner path. Specific examples of such methods include an intermittent impact using a typical cam and lever, or vibration by using a motor or a solenoid.

As the powder pumping system, a fixed hollow elastic member and a spirally curved rigid axis contacting an inner wall of the fixed hollow elastic member can be used. For example, a suction type one axis de-centering screw pump (referred to as Mono pump) is preferred. The structure thereof is formed of a de-centered rotor having a screw form made of a rigid material, for example, a metal, a stator formed of rubber having a two-pitched screw form in its inside and provided in a fixed manner, and a holder formed of a resin, etc., forming a path for toner powder. When the rotor rotates, the pump has a strong suction force and can suck an air stream containing toner. Furthermore, when the above-described air pump (air influx device 30) is used in addition to the powder pump portion, the fluidity of toner is promoted by the supplied air and the toner supply by the powder pump is secured.

As described above, the toner powder is supplied from the toner container 40 to a development portion 10 with the air stream functioning as transfer medium of the toner powder. The development portion 10 is structured of stirring screws 12 and 13 and a development sleeve 11 provided opposing an image bearing member (photoreceptor) 1. The supplied toner powder is homogeneous in density and suitably charged in a developing agent circulating between the stirring screws 12 and 13. Furthermore, the developing agent is moved to the development sleeve 11 and develops a latent electrostatic image formed on the image bearing member 1. This is a mere example and other development devices and systems can be used.

Next, a toner container for use in the present invention is described.

The toner powder container is formed of a bag structured by a single-layered or multi-layered flexible sheet and a connecting portion. FIG. 2 is a diagram illustrating a specific example of the toner container and FIG. 3 is a diagram illustrating a form when the toner container illustrated in FIG. 2 is reduced in volume. The toner container 40 is structured by a rigid mouth 41 and a soft and flexible bag 42. Typical molding materials, for example, polyethylene, polypropylene, nylon, ABS resin and NBS resin, can be used to form the mouth 41. Plastic film of, for example, polyethylene, polypropylene, polyester and polyurethane or paper, can be used to form the bag 42. In the case of a plastic film, the thickness thereof is preferably from about 0.05 to about 0.5 mm.

When the toner container is flexible, as the toner is sucked, the volume of the bag 41 is reduced. Toner clogging caused by local transformation of the toner container having a bag form that occurs when the volume of the bag is reduced is prevented by introduced air and at the same time, the suction efficiency of the powder pump increases. Therefore, the toner accommodated in the toner container is completely discharged from the bag 41.

The toner container 40 is connected with a development portion 10 via a tube 16. The tube 16 is, for example, a flexible tube having a diameter of from 4 to 10 mm and preferably formed of rubber material having toner-resistance property. Specific examples thereof include polyurethane, nitrile, EPDM and silicone rubber.

The crystalline polyester resin for use in the present invention is further described below.

The crystalline polyester resin for use in the present invention includes a structure of a carboxylic acid unit (—OOC—R—CO—) and a polyol unit (—O—(CH₂)ₙ—), specifically represented by the following chemical formula: —OOC—R—COO—(CH₂)ₙ— (in the formula, R represents a straight chain unsaturated aliphatic group having 2 to 20 carbon atoms and n represents an integer of from 1 to 20) in an amount of at least 60 mol % based on the entire ester linkages in the entire resin.

In the chemical formula, R is preferably a straight chain unsaturated aliphatic dicarboxylic acid residual group with 2 to 20 carbon atoms and more preferably a straight chain unsaturated aliphatic group having 2 to 4 carbon atoms. n is preferably an integer of from 2 to 6.

Specific examples of the straight chain unsaturated aliphatic group includes, but are not limited to, straight chain unsaturated aliphatic groups derived from a straight chain unsaturated dicarboxylic acid, for example, maleic acid, fumaric acid, 1,3-n-propane dicarboxylic acid, and 1,4-n-butane dicarboxylic acid.

(CH₂)ₙ represents a straight chain aliphatic diol residual group. Specific examples of the straight chain aliphatic diol residual groups in this case include, but are not limited to, groups introduced by a straight chain aliphatic diol, for example, ethylene glycol, 1,3-propylene glycol, 1,4-butane diol, and 1,6-hexane diol. The crystalline polyester resin uses a straight chain unsaturated aliphatic dicarboxylic acid unit as the carboxylic acid unit and therefore, relatively easily forms a crystal structure in comparison with the case in which an aromatic dicarboxylic acid unit is used.

The crystalline polyester resin has a crystalline property and a thermal melting characteristic in which the viscosity sharply drops at a temperature around the fixing start temperature. That is, the crystalline polyester resin has a good high temperature preservability due to the crystalline property until just below the melting starting temperature and the viscosity of the resin sharply drops (sharp melt property) at the melting start temperature so that toner having a good combination of high temperature preservability and low temperature fixability can be manufactured. In addition, the releasing width (the difference between the lowest fixing temperature and the temperature at which hot offset occurs) is good.

The crystalline property of the crystalline polyester resin for use in the present invention can be confirmed by diffraction peaks observed at 19 to 20°, 21 to 22°, 23 to 25° and 29 to 31° in the diffraction patterns (2θ) by a powder X ray diffraction device.

The crystalline polyester resin can be manufactured by conducting a polycondensation reaction of (1) a polycarboxylic acid unit formed of a straight chain unsaturated aliphatic dicarboxylic acid or its reactive derivative (e.g., an anhydride, a lower alkyl ester acid halide having 1 to 4 carbon atoms) and (2) a polyol unit formed of a straight chain aliphatic diol, by a typical method. The polycarboxylic acid unit can be used with a small amount of another kind of polycarboxylic acid unit, if desired. Specific examples of the polycarboxylic acid unit include, but are not limited to, (1) unsaturated aliphatic dicarboxylic acid units having a branch chain; (2) units of saturated aliphatic polycarboxylic acid such as saturated dicarboxylic acid and saturated aliphatic tricarboxylic acid; and (3) units of aromatic polycarboxylic acid such as aromatic dicarboxylic acid and aromatic tricarboxylic acid. The content of these polycarboxylic acid units are not greater than 30 mol % and preferably not greater than 10 mol %. These units are suitably added in the range in which the polyester can obtain a crystalline property.

The crystalline polyester for use in the present invention is obtained by using one or more alcohol components formed of di- or higher alcohol and one or more carboxylic acid components formed of di- or higher carboxylic acid compound. In the present invention, to form a non-straight polyester, a tri- or higher functional monomer selected from the group consisting of tri- or higher alcohols and tri- or higher carboxylic acid compounds is used in an amount of from 0.1 to 20 mol, preferably from 0.5 to 15 mol and more preferably from 1 to 13 mol based on 100 mol of all alcohol components.

Specific examples of the diols include, but are not limited to, ethylene glycol, 1,2-propylene glycol, 1,3-propylene glycol, 1,4-butanediol and neopentyl glycol, 1,5-pentane diol, 1,6-hexanediol, 1,8-octane diol, 1,4-cyclohexane dimethanol, hydrogenated bisphenol A, 1,4-butene diol, diethylene glycol, triethylene glycol, dipropylene glycol, polyethylene glycol, polypropylene glycol, and polytetramethylene glycol. Among these, in terms of the softening point and crystalline property of a resin, diols having 2 to 6 carbon atoms, for example, ethylene glycol, 1,2-propylene glycol, 1,3-propylene glycol, 1,4-butane diol, 1,5-pentane diol, 1,6-hexanediol and neopentyl glycol, are preferred. α,ω-straight chain alkylene glycols are more preferred and 1,4-butane diol is particularly preferred.

Such diols having 2 to 6 carbon atoms are preferably contained in an amount of not less than 50 mol %, more preferably from 60 to 80 mol % and particularly preferably from 80 to 100 mol %.

Specific examples of the tri- or higher alcohols include, but are not limited to, sorbitol, 1,2,3,6-hexane tetrol, 1,4-sorbitane, pentaerythritol, di-pentaerythritol, tri-pentaerythritol, 1,2,4-butane triol, 1,2,5-pentane triol, glycerin, 2-methyl propane triol, 2-methyl-1,2,4-butane triol, trimethylol ethane, trimethylol propane, and 1,3,5-trihydroxy methyl benzene. Among these, in terms of the softening point and crystalline property, glycerin is preferred.

In addition, specific examples of the di- or higher carboxylic acid compounds include, but are not limited to, aliphatic carboxylic acid, for example, oxalic acid, fumaric acid, maleic acid, citraconic acid, itaconic acid, glutaconic acid, succinic acid, adipic acid and sebacic acid, azelaic acid, malonic acid, and dodecenyl succinic acid and octyl succinic acid which are formed by substituting succinic acid with an alkyl group having 1 to 20 carbon atoms or an alkenyl group having 2 to 20 carbon atoms; aromatic carboxylic acids, for example, phthalic acid, isophthalic acid and terephthalic acid; cyclic carboxylic acids, for example, cyclohexane dicarboxylic acid and anhydrides thereof; and derivatives of alkyl esters having 1 to 3 carbon atoms. Among these, in terms of the softening point and the crystalline property, an aliphatic carboxylic acid is preferred and fumaric acid is more preferred.

The aliphatic carboxylic acid is preferably contained in the carboxylic acid component in an amount of not less than 70 mol % and more preferably from 80 to 100 mol %.

Specific examples of polycarboxylic acid units which can be added if desired include, but are not limited to, dicarboxylic acid units of, for example, moronic acid, succinic acid, glutaconic acid, adipic acid, suberic acid, sebacic acid, citracon acid, phthalic acid, isophthalic acid, and terephthalic acid; and tri- or higher carboxylic acid units of, for example, trimellitic anhydride, 1,2,4-benzene tricarboxylic acid, 1,2,5-benzene tricarboxylic acid, 1,2,4-cyclohexane tricarboxylic acid, 1,2,4-naphtalene tricarboxylic acid, 1,2,5-hexane tricarboxylic acid, 1,3-dicarboxyl-2-methylene carboxypropane, 1,2,7,8-octane tetra carboxylic acid. Among these, in terms of the softening point and the crystalline property, trimellitic acid and an anhydride thereof are preferred.

The alcohol component and the carboxylic acid component can be polycondensed by conducting a reaction in an inert gas atmosphere with an optional esterification catalyst in the range of from 150 to 250° C.

The softening point of the crystalline polyester is preferably from 85 to 140° C., more preferably from 100 to 140° C. and particularly preferably from 100 to 130° C.

Since the hybrid resin for use in the present invention is manufactured by chemically combining a polycondensation based resin and an addition polymerization based resin, it is preferred to conduct the polymerization using a compound reactive with the monomers of both resins. Specific examples of the monomers reactive with both resins include, but are not limited to, fumaric acid, acrylic acid, methacrylic acid, maleic acid, and dimethyl fumarate.

The content of the monomer reactive with both resins is from 1 to 25 parts by weight and preferably from 2 to 10 parts by weight based on 100 parts by weight of the material monomer of the addition polymerization based resin. When the content is too small, dispersion of a colorant and/or a charge control agent tends to deteriorate, resulting in deterioration of image quality, for example, occurrence of fogging. When the content is too large, the resin easily turns into a gel.

It is not necessary to conduct and/or complete both reactions simultaneously to prepare the hybrid resin described above. It is possible to separately select a suitable temperature range and time for each reaction. For example, there is a method as follows: (1) Drop a mixture containing an addition polymerization based material monomer of a vinyl based resin and a polymerization initiator to preliminarily mix with a mixture of a polycondensation based material monomer of a polyester resin in a reaction container and to complete the polymerization reaction for the vinyl based resin by a radical reaction; and (2) raise the reaction temperature to complete the polycondensation reaction of the polyester resin. In this method, by conducting two separate reactions sequentially in a reaction container, it is possible to effectively disperse two kinds of resins.

The acid value of the hybrid resin is preferably from 15 to 70 mgKOH, preferably from 20 to 50 mgKOH and more preferably from 20 to 30 mgKOH. In this range, the dispersion effect of a release agent is high and the low temperature fixability and the environmental stability are excellent. This is thought to be because, by raising the acid value, the compatibility between paper and a resin ameliorates so that the low temperature fixability is improved. When the acid value is too low, the release agent packed and dispersed in a hybrid resin tends to be separated from polyester. When the acid value is too high, the moisture in the atmosphere tends to have a large impact and the amount of charge in toner is unstable.

The non-crystalline polyester resin for use in the present invention is obtained by polycondensation reaction between a polycarboxylic acid component and a polyol component. Specific examples of the polycarboxylic acid components include, but are not limited to, dicarboxylic acids with optional tri- or higher carboxylic acids. Specific examples of the dicarboxylic acids include, but are not limited to: (1) aliphatic dicarboxylic acids having 2 to 20 carbon atoms, for example, maleic acid, fumaric acid, succinic acid, adipic acid, sebacic acid, maronic acid, azelaic acid, mesaconic acid, citraconic acid, and glutaconic acid; (2) alicyclic dicarboxylic acids having 8 to 20 carbon atoms, for example, cyclohexane dicarboxylic acid and methylmedic acid; (3) aromatic dicaroxylic acids having 8 to 20 carbon atoms, for example, phthalic acid, isophthalic acid, terephthalic acid, toluene dicarboxylic acid, naphthalene dicarboxylic acid; (4) alkyl succinic acid or alkenyl succinic acid, for example, isododecenyl succinic acid and n-dodecenyl succinic acid, having a hydrocarbon group having 4 to 35 carbon atoms in its branch chain; and (5) anhydrides and lower alkyl (e.g., methyl and butyl) esters of these dicarboxylic acids.

Among these, (1), (3), (4) and (5) are preferred. Maleic acid including an anhydride thereof, fumaric acid, isophthalic acid, terephthalic acid, dimethyl terephthalate, n-dodecenyl succinic acid including an anhydride thereof are further preferred. Specific examples of tri- or higher carboxylic acids include, but are not limited to: (1) aliphatic polycarboxylic acids having 7 to 20 carbon atoms, for example, 1,2,4-butane tricarboxylic acid, 1,2,5-hexane tricarboxylic acid, 1,3-dicarboxyl-2-methyl-2-methylene carboxy propane, tetra(methylene carboxyl)methane, 1,2,7,8-octane tetracarboxylic acid; (2) cyclic polycarboxylic acid having 9 to 20 carbon atoms, for example, 1,2,4-cyclohexane tricarboxylic acid; (3) aromatic polycarboxylic acids having 9 to 20 carbon atoms, for example, 1,2,4-benzene tricarboxylic acid, 1,2,5-benzene tricarboxylic acid, 2,5,7-naphthalene tricarboxylic acid and 1,2,4-naphthalene tricarboxylic acid, pyromellitic acid, and benzophenone tetracarboxylic acid; and (4) anhydrides and lower alkyl (e.g., methyl and butyl) esters thereof.

When a tri- or higher carboxylic acid is used, (3) mentioned above and anhydrides or lower alkyl esters thereof are preferred. However, the usage of such compounds tends to have an adverse impact on gloss or transparency and thus the content thereof is limited to a small amount.

Specific examples of polyol components include, but are not limited to, as diols, (1) alkylene glycols having 2 to 12 carbon atoms, for example, ethylene glycol, 1,2-propylene glycol, 1,3-propylene glycol, 1,4-butane diol, neopentyl glycol, 1,4-butene diol, 1,5-pentane diol, and 1,6-hexane diol; (2) alkylene ether glycols, for example, diethylene glycol, triethylene glycol, dipropylene glycol, polyethylene glycol, polypropylene glycol and polytetramethylene glycol; and (3) alicyclic diols, for example, 1,4-cyclohexane dimethanol, and hydrogenated bisphenol A; (4) bisphenols, for example, bisphenol A, bisphenol F and bisphenol S; and (5) adducts of bisphenol of (4) with 2 to 8 mol of alkylene oxides (EO, PO and butylenes oxide). Among these, (1) and (5) are preferred and (5) are more preferred. In addition, among (5), an adduct of bisphenol A with 2 to 4 mol of EO and/or PO is particularly preferred in light of imparting to the toner a good anti-offset property.

Specific examples of tri- or higher alcohols include, but are not limited to, (1) aliphatic polyols having 3 to 20 carbon atoms, for example, sorbitol, 1,2,3,6-hexane tetrol, 1,4-sorbitan, pentaerythritol, dipentaerythritol, tripentaerythritol, 1,2,4-butane triol, 1,2,5-pentatriol, glycerol, 2-methyl propane triol, 2-methyl-1,2,4-butane triol, trimethylol ethane, and trimethylol propane; (2) aromatic polyols having 6 to 20 carbon atoms, for example, 1,3,5-trihydroxyl methylbenzene; and (3) adducts of alkylene oxides thereof. When a tri- or higher alcohol is used, (1) is preferred and among (1), glycerol, trimethylol propane and pentaerythritol are preferred in terms of inexpensiveness. However, the usage of such compounds tends to have an adverse impact on gloss or transparency and thus the content thereof is limited to a small amount.

Any known pigments and dyes from which yellow, magenta, cyan and black toner can be obtained are used as the colorants for use in the present invention.

Specific examples of yellow pigments include, but are not limited to, cadmium Yellow, mineral fast yellow, nickel titan yellow, navels yellow, naphthol yellow S, hansa yellow G, hansa yellow 10G, benzidine yellow GR, quinoline yellow lake, permanent yellow NCG and tartrazine lake.

Specific examples of orange pigments include, but are not limited to, molybdenum orange, permanent orange GTR, pyrazolone orange, vulcan orange, indanthrene brilliant orange RK, benzidine orange G and indanthrene brilliant orange GK.

Specific examples of red pigments include, but are not limited to, colcothar, cadmium red, permanent red 4R, lithol red, pyrazolone red, watching red calcium salt, lake red D, brilliant carmine 6B, rhodamine lake B, alizarine lake and brilliant carmine 3B.

Specific examples of violet pigments include, but are not limited to, fast violet B and methyl violet lake.

Specific examples of blue pigments include, but are not limited to, cobalt blue, alkali blue, victoria blue lake, phthalocyanine blue, metal-free phthalocyanine blue, a chlorinate of phthalocyanine blue portion, fast sky blue and indanthrene blue BC.

Specific examples of green pigments include, but are not limited to, chrome green, a chrome oxide, pigment green B and malachite green lake.

Specific examples of black pigments include, but are not limited to, azine containing colorants, for example, carbon black, oil furnace black, channel black, lamp black, acetylene black, aniline black, metal salt azo colorants, metal oxides and complex metal oxides

These can be used alone or in combination.

The toner of the present invention can contain a charge control agent, if desired. Specific examples thereof include, but are not limited to: nigrosine; azine based dyes; basic dyes (for example, C.I. Basic Yellow 2 (C.I. 41000), C.I. Basic Yellow 3 (C.I. 41000), C.I. Basic Red 1 (C.I. 45160), C.I. Basic Red 9 (C.I. 42500), C.I. Basic Violet 1 (C.I. 42535), C.I. Basic Violet 3 (C.I. 42555), C.I. Basic Violet 10 (C.I. 45170), C.I. Basic Violet 14 (C.I. 42510), C.I. Basic Blue 1 (C.I. 42025), C.I. Basic Blue 3 (C.I. 51005), C.I. Basic Blue 5 (C.I. 42140), C.I. Basic Blue 7 (C.I. 42595), C.I. Basic Blue 9 (C.I. 52015), C.I. Basic Blue 24 (C.I. 52030), C.I. Basic Blue 25 (C.I. 52025), C.I. Basic Blue 26 (C.I. 44045), C.I. Basic Green 1 (C.I. 42040) and C.I. Basic Green 4 (C.I. 420000); lake pigments of basic dyes thereof; C.I. Solvent Black 8 (C.I. 26150); quaternary ammonium salts, for example, benzoyl methyl hexadecyl ammonium chloride and decyl trimethyl chloride; dialkyl (e.g., dibutyl or dioctyl) tin compounds; dialkyl tin oblate compounds; guanidine derivatives; vinyl based polymers having an amino group; polyamine resins, for example, condensation based polymers having an amino group; metal complex salts of monoazo dyes; metal complex salts of Zn, Al, Co, Cr, Fe, etc., of salicylic acid, dialkyl salicylic acid, naphthoic acid and dicarboxylic acid; sulfonated copper phthalocyanine pigments; organic boron salts; quaternary ammonium salts containing fluorine; and calix arene based compounds. The usage of a charge control agent which bars the target color of a toner should be avoided and thus, for example, metal salts of white color salicylic acid derivatives are suitably used.

The toner of the present invention can contain a release agent. Any known release agents can be used. Especially, a single or combinational use of carnauba wax which is subject to a treatment of eliminating free aliphatic acid therefrom, montan wax, and oxidized rice wax is good to improve dispersion effect. With regard to carnauba wax, carnauba wax having fine crystalline property with an acid value of not greater than 5 is preferred. In addition, the particle diameter is preferably not greater than 1 μm when dispersed in a toner binder. Montan wax represents montan wax refined from minerals and is preferably fine crystalline with an acid value of from 5 to 14 like carnauba wax. Oxidized rice wax is a wax obtained by oxidizing rice bran wax with air and preferably has an acid value of from 10 to 30. As other release agents, any known releasing agents, for example, solid silicone varnish, higher aliphatic acid higher alcohol, montan based ester wax, low molecular weight polypropylene wax, can be also mixed in combination. The volume average particle diameter of a release agent before dispersing in a toner binder is preferably from 10 to 800 μm. When the volume average particle diameter is too small, the dispersion particle diameter in a toner binder tends to be small so that the release effect is not sufficient, resulting in occurrence of offset. When the volume average particle diameter is too large, the dispersion particle diameter of the release agent in a toner binder tends to be large so that precipitation of the release agent increases, resulting in deterioration of fluidity and fixation in a development device. The particle diameter is measured by using a laser diffraction and scattering type particle size distribution analyzer (LA-920, manufactured by Horiba Ltd.).

With regard to the toner of the present invention, the transferability and durability can be improved by externally adding inorganic particulates and/or resin particulates, for example, silica, titanium oxide, alumina, silicon carbide, and boron nitride, to mother toner particles. Wax degrades transferability and durability of toner but such particulates cover the surface of toner and wax and decrease the contact area thereof. Thus, this effect is obtained. The surface of these inorganic particulates is preferably subject to hydrophobizing treatment. Metal oxide particulates, for example, hydrophobized silica and titanium oxide, are suitably used. As resin particulates, polymethyl methacrylate or polystyrene particulates having an average particle diameter of from about 0.05 to about 1 μm obtained by a soap-free emulsification polymerization method is suitably used. Furthermore, by using hydrophobized titanium oxide with a smaller amount of hydrophobized silica than that of the hydrophobized titanium in combination, toner can have excellent stable chargeability to humidity.

It is possible to improve the durability of a toner by externally adding an external additive having a larger particle diameter than that of a typically used external additive, for example, silica having a specific surface area of from 20 to 50 m²/g and a resin particulate having an average particle diameter of from 1/100 to ⅛ of that of a mother toner particle, in combination with the inorganic particulates described above. This is explained as follows: Metal oxide particulates externally added to toner tend to be embedded in mother toner particles in the process of charging toner by mixing and stirring with carrier in a development device. However, by externally adding an external additive having a larger particle diameter than that of the metal oxide particulates, such metal oxide particulates are prevented from being embedded in the toner.

When the inorganic particulates and/or the resin particulates mentioned above are contained (internally added) in a toner, it is also possible to obtain the effect of improving the transferability and durability. However, the effect is less than in the case of the external addition. In addition, the pulverization property of toner is also improved. Furthermore, when such internally added particulates are used in combination with externally added particulates, it is possible to prevent the externally added particulates from being embedded in toner. Therefore, excellent transferability is obtained and the durability is improved.

Specific examples of the hydrophobizing agent for use include, but are not limited to, the following: Dimethyl dichlorosilane, trimethyl chlorosilane, methyl trichlorosilane, allyldimethyl dichlorosilane, allylphenyl dichlorosilane, benzyl dimethylchlorosilane, bromomethyl dimethyl chlorosilane, α-chloroethyl trichlorosilane, p-chloroethyl trichlorosilane, chloromethyl dimethylchlorosilane, chloromethyl trimethylchlorosilane, p-chlorophenyl trichlorosilane, 3-chloropropyl trichlorosilane, 3-chloropropyl trimethoxysilane, vinyl triethoxysilane, vinyl methoxysilane, vinyl-tris(β-methoxyethoxy)silane, γ-methacryloxy propyltrimethoxysilane, vinyltriacetoxysilane, divinyldichlorosilane, dimethylvinyl chlorosilane, octyl-trichlorosilane, decyl-trichlorosilane, nonyl-trichlorosilane, (4-t-propylphenyl)-trichlorosilane, (4-t-butylphenyl)-trichlorosilane, dipentyl-dichlorosilane, dihexyl-dichlorosilane, dioctyl-dichlorosilane, dinonyl-dichlorosilane, didecyl-dichlorosilane, didodecyl-dichlorosilane, dihexadecyl-dichlorosilane, (4-t-butylphenyl)-octyl-dichlorosilane, dioctyl-dichlorosilane, didecenyl-dichlorosilane, dinonenyl-dichlorosilane, di-2-ethylhexyl-dichlorosilane, di-3,3-dimethylpentyl-dichlorosilane, trihexyl-chlorosilane, trioctyl-chlorosilane, tridecyl-chlorosilane, dioctyl-methyl-chlorosilane, octyl-dimethyl-chlorosilane, (4-t-propylphenyl)-diethyl-chlorosilane, octyltrimethoxysilane, hexamethyldisilazane, hexaethyldisilazane, diethyltetramethyldisilazane, hexaphenyldisilazane and hexatrildisilazane. In addition thereto, titanate based coupling agents and aluminum-based coupling agents can be used. Furthermore, as an external additive to improve cleanability, lubricants, for example, particulates of aliphatic metal salts and polyvinlydene fluoride, can be used.

The color toner of the present invention can be used in combination with carrier powder as a two component developing agent. Any known carrier can be used. For example, ferrite powder, magnetite powder, nickel powder and glass beads can be used as a carrier. The surface thereof can be covered with a resin, etc. Specific examples of such resins include, but are not limited to, silicon based resins, fluorine based resin and acryl based resins. The volume average particle diameter of carrier is preferably from 25 to 200 μm. The content ratio of toner to carrier depends on the particle diameters thereof and is preferably from about 1:99 to about 10:90.

As the method of manufacturing the toner of the present invention, a method can be applied which includes a process of mechanically mixing a developing agent component containing at least a binder resin, a main charge control agent and a pigment, a process of melting and kneading the mixture, a process of pulverizing the obtained mixture and classifying the resultant. Powder that is not usable as product after pulverization and classification can be returned to the process of mechanical mixing or melting and kneading for recycle use. To improve the dispersing property of a pigment, the pigment can be mixed with other materials after the pigment is subject to a master batch treatment.

The powder (by-product) that is not usable as a product represents particulates and coarse particles other than particles having a desired particle diameter as a product in the pulverization process after the melting and the kneading process and/or particulates and coarse particles other than particles having a desired particle diameter as a product in the subsequent process, i.e., classification process. It is preferred to mix such a by-product with raw material at a ratio (by-product to raw material) of from 1/99 to 50/50 by weight.

There is no specific limit to the process of mechanically mixing a developing agent component containing at least a binder resin, a main charge control agent, a pigment and a by-product. A typical mixer having a rotating wing can be used under a typical condition.

When finished with the mixing process, the mixture is placed in a mixing and kneading machine and melted and kneaded therein. Specific examples of such mixing and kneading machines include, but are not limited to, a batch type two roll, a Bunbury mixer and a continuous two-axis extruder. Specific examples thereof include a KTK type two axis extruder (manufactured by Kobe Steel Ltd.), a TEM type two axis extruder (manufactured by Toshiba Machine Co., Ltd.), a two axis extruder (manufactured by KCK Co., Ltd.), a PCM type two axis extruder (manufactured by Ikegai Co., Ltd.) and a KEX type two axis extruder (manufactured by Kurimoto Ltd.). Furthermore, a continuous one axis mixing and kneading machine, for example, a co-kneader (manufactured by Buss CO., Ltd.), can be suitably used.

The thus-obtained melted and kneaded resultant is pulverized subsequent to cooling-down. The resultant is coarse-pulverized by using a hammer mill, or a ROTOPLEX, followed by fine pulverization by using a fine powder pulverizer and a mechanical fine powder pulverizer. It is preferred to perform pulverization such that the average particle diameter of the resultant is from 3 to 15 μm. In addition, the particle size of the pulverized resultant is adjusted by an air-driven classifier, etc. to have an average particle diameter of from 2.5 to 20 μm. An external additive is externally added to mother toner. When mother toner particles and an external additive are mixed and stirred by a mixer, the external additive covers the surface of toner while the external additive is pulverized. At this point, it is desired that the inorganic particulates and resin particulates are externally and firmly added to mother toner to improve the durability of the toner.

The peak top molecular weight (MPT) of toner is measured as follows: Stabilize a column in a heat chamber at 40° C. in a GPC measuring device; Flow tetrahydrofuran (THF) in the column at a flow speed of 1 ml/minute at this temperature as a solvent; and measure the peak top molecular weight after injection of tetrahydrofuran sample liquid. With regard to the molecular weight measurement of the sample, the molecular weight distribution of the sample is calculated based on the relationship between the logarithmic value of analytical curve made from several kinds of simple-dispersion polystyrene standard samples and the number of counts.

As the standard polystyrene sample for use in making the analytical curve, the sample manufactured by, for example, Tosoh Corporation or Showa Denko K.K., having a molecular weight of from about 10² to about 10⁷, is used and it is suitable to use at least about ten standard polystyrene samples. As for the detector, a differential refractive index (RI) detector is used. As the column, it is good to use several marketed polystyrene gel columns in combination. For example, a combination of columns, for example, Shodex GPC KF-801, 802, 803, 804, 805, 806, 807 and 800P (manufactured by Showa Denko K.K.) or a combination of columns, for example, TSK gel G1000H(HXL), G2000H(HXL), G3000H(HXL), G4000H (HXL), G5000H(HXL), G6000H(HXL), G7000 (HXL) and TSK guard column (manufactured by Tosoh Corporation) can be used.

Generally, in the GPC chromatogram, measurement starts from where the chromatogram starts to rise from the base line on the high molecular weight side. On the low molecular weight side, the measurement is made until the molecular weight is about 400.

Having generally described preferred embodiments of this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

The present invention is further detailed with reference to Examples but not limited thereto.

### Synthesis Example

### Synthesis of Crystalline Polyester PC1

The following recipe is placed in a flask (5 liter) equipped with a nitrogen introduction tube, a dewatering tube, a stirrer and a thermocouple and is reacted at 160° C. for 5 hours. Thereafter, the system is heated to 200° C. and the reaction is conducted for one hour followed by another hour at 8.3 kPA to obtain crystalline polyester pC1.

The crystalline property is confirmed by diffraction peaks observed at 19 to 20° (2θ), 21 to 22° (2θ), 23 to 25° (2θ) and 29 to 31° (2θ) of the diffraction patterns by a powder X ray diffraction device (RINT 1100, manufactured by Rigaku Corporation). In addition, by solid ¹³C-NMR, the existence of the structure of a unit of —OCOC—R—COO—(CH₂)ₙ— (in the structure, R represents an unsaturated straight chain aliphatic group having 2 to 20 carbon atoms and n represents an integer of from 2 to 20) including a carboxylic acid unit (—OOC—R—CO—) and a polyalcohol unit (—O—(CH₂)ₙ—) are confirmed.

| | | |
|---|---|---|
| 1,4-butane diol | 1,150 | g |
| glycerin | 80 | g |
| fumaric acid | 1,400 | g |
| trimellitic anhydride | 350 | g |
| tin octylate | 3.5 | g |
| hydroquinone | 1.5 | g |

### Synthesis of Crystalline Polyester PC2

The following recipe is placed in a flask (5 liter) equipped with a nitrogen introduction tube, dewatering tube, a stirrer and a thermocouple and is reacted at 160° C. for 5 hours. Thereafter, the system is heated to 200° C. and the reaction is conducted for one hour followed by another hour at 8.3 kPA to obtain crystalline polyester pC2.

The crystalline property is confirmed by diffraction peaks observed at 19 to 20° (2θ), 21 to 22° (2θ), 23 to 25° (2θ) and 29 to 31° (2θ) of the diffraction patterns by a powder X ray diffraction device (RINT 1100, manufactured by Rigaku Corporation. In addition, by solid ¹³C-NMR, the existence of the structure of a unit of —OOC—R—COO—(CH₂)ₙ— (in the structure, R represents an unsaturated straight chain aliphatic group having 2 to 20 carbon atoms and n represents the number of repeated units of methylene chain and an integer of from 2 to 20) including a carboxylic acid unit (—OOC—R—CO—) and a polyalcohol unit (—O—(CH₂)ₙ—) are confirmed.

| | | |
|---|---|---|
| 1,6-butane diol | 1,260 | g |
| ethylene glycol | 120 | g |
| maleic acid | 1,800 | g |
| trimellitic anhydride | 300 | g |
| tin dibutylate | 2.5 | g |
| hydroquinone | 1.5 | g |

### Synthesis of Hybrid Resin HB1

30 mol of styrene and 10 mol of butyl methacrylate as addition polymerization reaction monomers and 0.9 mol of t-butylhydroperoxide as a polymerization initiator are set in a dripping funnel. 25 mol of phthalic acid as a monomer serving as both an addition polymerization monomer and a polycondensation monomer and 5 mol of trimellitic anhydride as a polycondensation monomer, 20 mol of bisphenol A (2,2) propylene oxide, 10 mol of bisphenol A (2,2) ethylene oxide and 8 mol of tin dioctanate as an esterification catalyst are placed in a flask equipped with a stainless stirrer, a flow-down condenser, a nitrogen introduction tube and a thermometer, and stirred at 135° C. in nitrogen atmosphere while the mixture of the addition polymerization based material is dropped from the dripping funnel in 5 hours. The resultant is aged for 6 hours at 130° C. and is heated to 220° C. to obtain a hybrid resin HB1. The peak top molecular weight thereof is 3,500.

### Synthesis of Non-Crystalline Polyester NC1 to NC5

### NC1

The following recipe is placed in a reaction container equipped with a condenser, a stirrer and a nitrogen introduction tube and is reacted in nitrogen atmosphere at 230° C. for 2 hours while removing water produced during the reaction. The resultant is reacted for 1 hour with a reduced pressure of 5 to 20 mmHG. Subsequent to addition of 8 mol of trimellitic anhydride thereto, the reaction is conducted for 2 hours under the condition of airtight normal pressure. The resultant is taken out and cooled down to room temperature followed by pulverization to obtain NC1. NC1 has a peak top molecular weight of 3,000 and a softening point of 170° C. G′ (0.01 Hz)/G′ (1 Hz) is 0.80.

| | | |
|---|---|---|
| 1,3-propylene glycol | 30 | mol |
| diethylene glycol, | 20 | mol |
| phthalic acid | 20 | mol |
| adipic acid | 22 | mol |
| tin (II) oxalate | 1.5 | parts |

The following recipe is placed in a reaction container equipped with a condenser, a stirrer and a nitrogen introduction tube and is reacted in nitrogen atmosphere at 230° C. for 2 hours while removing water produced during the reaction. The resultant is reacted for 3 hours with a reduced pressure of 5 to 20 mmHG, taken out and cooled down to room temperature. NC2 is obtained after pulverization. NC2 has a peak top molecular weight of 4,200 and a softening point of 115° C. G′ (0.01 Hz)/G′ (1 Hz) is 0.01.

| | | |
|---|---|---|
| 1,3-propylene glycol | 30 | mol |
| diethylene glycol, | 20 | mol |
| phthalic acid | 20 | mol |
| adipic acid | 18 | mol |
| tin (II) distearoxy | 2.5 | parts |

The following recipe is placed in a reaction container equipped with a condenser, a stirrer and a nitrogen introduction tube and is reacted in nitrogen atmosphere at 230° C. for 2 hours while removing water produced during the reaction. The resultant is reacted for 3 hours with a reduced pressure of 5 to 20 mmHG, taken out and cooled down to room temperature. NC3 is obtained after pulverization. NC3 has a peak top molecular weight of 2,800 and a softening point of 120° C. G′ (0.01 Hz)/G′ (1 Hz) is 0.008.

| | | |
|---|---|---|
| 1,3-propylene glycol | 30 | mol |
| diethylene glycol, | 20 | mol |
| phthalic acid | 30 | mol |
| adipic acid | 15 | mol |
| trimellitic anhydride | 5 | mol |
| tin (II) diolate | 2.0 | parts |

The following recipe is placed in a reaction container equipped with a condenser, a stirrer and a nitrogen introduction tube and is reacted in nitrogen atmosphere at 230° C. for 2 hours while removing water produced during the reaction. The resultant is reacted for 1 hour with a reduced pressure of 5 to 20 mmHG. Subsequent to addition of 15 mol of 1,2,4-butane triol, the reaction is conducted for 2 hours under the condition of airtight normal pressure. The resultant is taken out and cooled down to room temperature followed by pulverization to obtain NC4. NC4 has a peak top molecular weight of 7,100 and a softening point of 160° C. G′ (0.01 Hz)/G′ (1 Hz) is 0.90.

| | | |
|---|---|---|
| adducts of bisphenol A with propylene oxide | 50 | mol |
| isophthalic acid | 35 | mol |
| terephthalic acid | 15 | mol |
| tin (II) octylate | 2.0 | parts |

The following recipe is placed in a reaction container equipped with a condenser, a stirrer and a nitrogen introduction tube and is reacted in nitrogen atmosphere at 230° C. for 2 hours while removing water produced during the reaction. The resultant is reacted for 1 hour with a reduced pressure of 5 to 20 mmHG. Subsequent to addition of 10 mol of trimellitic anhydride, the reaction is conducted for 2 hours under the condition of airtight normal pressure. The resultant is taken out and cooled down to room temperature followed by pulverization to obtain NC5. NC5 has a peak top molecular weight of 5,200 and a softening point of 140° C. G′ (0.01 Hz)/G′ (1 Hz) is 0.20.

| | | |
|---|---|---|
| adducts of bisphenol A with propylene oxide | 20 | mol |
| adducts of bisphenol A with ethylene oxide | 30 | parts |
| terephthalic acid | 15 | mol |
| succinic acid | 35 | mol |
| tin (II) octylate | 2.0 | parts |

### Example Toner 1

Recipe

| | |
|---|---|
| crystalline polyester resin PC1 | 30 parts |
| hybrid resin HB1 | 15 parts |
| non-crystalline polyester NC5 | 30 parts |
| zirconium complex of salicylic acid (X-11, manufactured by | 5 parts |
| Orient Chemical Industries. Ltd.) | |
| ester wax (WEP-2, manufactured by NOF corporation) | 10 parts |
| carbon black (REGAL 330 R, manufactured by Cabot Japan | 10 parts |
| K.K.) | |

The materials of the recipe described above are preliminarily mixed by a HENSCHEL MIXER (FM10B, manufactured by MITSUI MINING COMPANY, LIMITED) and mixed and kneaded at 120° C. by a two-axis kneader (PCM-30, manufactured by Ikegai Co., Ltd.). The resulting mixture is finely-pulverized using a supersonic wave jet pulverizer (Labojet, manufactured by Nippon Pneumatic MFG. Co., Ltd.) and the resultant is classified by an air-classifier (MDS-I, manufactured by Nippon Pneumatic MFG. Co., Ltd.) to prepare mother toner particles having a number average particle diameter of 6.5 μm, a standard deviation of 2.27 for number distribution, a variation coefficient (standard deviation of number distribution/number average particle diameter) of 35.0 and toner particles having a particle diameter of from 4.0 to 8.0 μm in an amount of 59% by number. 2.0 parts of colloidal silica (H-2000, manufactured by Clariant) is mixed with 100 parts of the mother toner particle by a sample mill to obtain Example Toner 1. The peak top molecular weight thereof is 4,800.

### Example Toner 2

| | |
|---|---|
| crystalline polyester resin PC1 | 18 parts |
| hybrid resin HB1 | 54 parts |
| non-crystalline polyester NC5 | 5 parts |
| zirconium complex of salicylic acid (X-11, manufactured by | 5 parts |
| Orient Chemical Industries. Ltd.) | |
| ester wax (WEP-2, manufactured by NOF corporation) | 8 parts |
| carbon black (REGAL 330 R, manufactured by Cabot Japan | 10 parts |
| K.K.) | |

The materials of the recipe described above are preliminarily mixed by a HENSCHEL MIXER (FM10B, manufactured by MITSUI MINING COMPANY, LIMITED) and mixed and kneaded at 70° C. by a two-axis kneader (PCM-30, manufactured by Ikegai Co., Ltd.). The resulting mixture is finely-pulverized using a supersonic wave jet pulverizer (Labojet, manufactured by Nippon Pneumatic MFG. Co., Ltd.) and the resultant is classified by an air-classifier (MDS-I, manufactured by Nippon Pneumatic MFG. Co., Ltd.) to prepare mother toner particles having a number average particle diameter of 3.5 μm, a standard deviation of 1.015 of number distribution, a variation coefficient (standard deviation of number distribution/number average particle diameter) of 29.0 and toner particles having a particle diameter of from 4.0 to 8.0 μm in an amount of 40% by number. 2.5 parts of colloidal silica (H-2150VP, manufactured by Clariant) is mixed with 100 parts of the mother toner particle by a sample mill to obtain Example Toner 2. The peak top molecular weight thereof is 2,500.

### Example Toner 3

The materials of the recipe of Example 2 are preliminarily mixed by a HENSCHEL MIXER (FM10B, manufactured by MITSUI MINING COMPANY, LIMITED) and mixed and kneaded at 110° C. by a two-axis kneader (PCM-30, manufactured by Ikegai Co., Ltd.). The resulting mixture is finely-pulverized using a supersonic wave jet pulverizer (Labojet, manufactured by Nippon Pneumatic MFG. Co., Ltd.) and the resultant is classified by an air-classifier (MDS-I, manufactured by Nippon Pneumatic MFG. Co., Ltd.) to prepare mother toner particles having a number average particle diameter of 5.6 μm, a standard deviation of 2.18 of number distribution, a variation coefficient (standard deviation of number distribution/number average particle diameter) of 38.9 and toner particles having a particle diameter of from 4.0 to 8.0 μm in an amount of 69% by number. 2.2 parts of colloidal silica (H-30, manufactured by Clariant) is mixed with 100 parts of the mother toner particle by a sample mill to obtain Example Toner 3. The peak top molecular weight thereof is 3,500.

### Example Toner 4

### Recipe

| | |
|---|---|
| crystalline polyester resin PC1 | 20 parts |
| hybrid resin HB1 | 40 parts |
| non-crystalline polyester NC4 | 20 parts |
| chromium based azo complex (S-34, manufactured by Orient | 3 parts |
| Chemical Industries. Ltd.) | |
| Ester wax (WEP-5, manufactured by NOF corporation) | 7 parts |
| Carbon black (REGAL 330 R, manufactured by Cabot Japan | 10 parts |
| K.K.) | |

The materials of the recipe described above are preliminarily mixed by a HENSCHEL MIXER (FM10B, manufactured by MITSUI MINING COMPANY, LIMITED) and mixed and kneaded at 110° C. by a two-axis kneader (PCM-30, manufactured by Ikegai Co., Ltd.). The resulting mixture is finely-pulverized using a supersonic wave jet pulverizer (Labojet, manufactured by Nippon Pneumatic MFG. Co., Ltd.) and the resultant is classified by an air-classifier (MDS-I, manufactured by Nippon Pneumatic MFG. Co., Ltd.) to prepare mother toner particles having a number average particle diameter of 4.3 μm, a standard deviation of 1.025 of number distribution, a variation coefficient (standard deviation of number distribution/number average particle diameter) of 23.8 and toner particles having a particle diameter of from 4.0 to 8.0 μm in an amount of 42% by number. 1.8 parts of colloidal silica (R-974, manufactured by Clariant) is mixed with 100 parts of the mother toner particle by a sample mill to obtain Example Toner 4. The peak top molecular weight thereof is 4,200.

### Example Toner 5

### Recipe

| | |
|---|---|
| crystalline polyester resin PC2 | 40 parts |
| hybrid resin HB1 | 25 parts |
| non-crystalline polyester NC3 | 17 parts |
| chromium based azo complex (Spiron Black, manufactured by | 3 parts |
| Hodogaya Chemical Co., Ltd.) | |
| ester wax (WEP-1, manufactured by NOF corporation) | 5 parts |
| carbon black (REGAL 330 R, manufactured by Cabot Japan | 10 parts |
| K.K.) | |

The materials of the recipe described above are preliminarily mixed by a HENSCHEL MIXER (FM10B, manufactured by MITSUI MINING COMPANY, LIMITED) and mixed and kneaded at 110° C. by a two-axis kneader (PCM-30, manufactured by Ikegai Co., Ltd.). The resulting mixture is finely-pulverized using a supersonic wave jet pulverizer (Labojet, manufactured by Nippon Pneumatic MFG. Co., Ltd.) and the resultant is classified by an air-classifier (MDS-I, manufactured by Nippon Pneumatic MFG. Co., Ltd.) to prepare mother toner particles having a number average particle diameter of 4.7 μm, a standard deviation of 1.06 of number distribution, a variation coefficient (standard deviation of number distribution/number average particle diameter) of 22.5 and toner particles having a particle diameter of from 4.0 to 8.0 μm in an amount of 58% by number. 2.0 parts of colloidal silica (R-974, manufactured by Clariant) is mixed with 100 parts of the mother toner particle by a sample mill to obtain Example Toner 5. The peak top molecular weight thereof is 2,800.

### Example Toner 6

### Recipe

| | |
|---|---|
| crystalline polyester resin PC1 | 35 parts |
| hybrid resin HB1 | 30 parts |
| non-crystalline polyester NC2 | 15 parts |
| chromium based azo complex (S-34, manufactured by Orient | |
| Chemical Industries. Ltd.) | |
| Ester wax (WEP-5, manufactured by NOF corporation) | 7 parts |
| Carbon black (REGAL 330 R, manufactured by Cabot Japan | 10 parts |
| K.K.) | |

The materials of the recipe described above are preliminarily mixed by a HENSCHEL MIXER (FM10B, manufactured by MITSUI MINING COMPANY, LIMITED) and mixed and kneaded at 130° C. by a two-axis kneader (PCM-30, manufactured by Ikegai Co., Ltd.). The resulting mixture is finely-pulverized using a supersonic wave jet pulverizer (Labojet, manufactured by Nippon Pneumatic MFG. Co., Ltd.) and the resultant is classified by an air-classifier (MDS-I, manufactured by Nippon Pneumatic MFG. Co., Ltd.) to prepare mother toner particles having a number average particle diameter of 3.7 μm, a standard deviation of 1.112 of number distribution, a variation coefficient (standard deviation of number distribution/number average particle diameter) of 31.8 and toner particles having a particle diameter of from 4.0 to 8.0 μm in an amount of 41% by number. 1.5 parts of colloidal silica (H-30, manufactured by Clariant) is mixed with 100 parts of the mother toner particle by a sample mill to obtain Example Toner 6. The peak top molecular weight thereof is 3,500.

### Example Toner 7

### Recipe

| | |
|---|---|
| crystalline polyester resin PC2 | 15 parts |
| hybrid resin HB1 | 25 parts |
| non-crystalline polyester NC1 | 40 parts |
| zinc (III) complex of salicylic acid (E-84, manufactured by | 5 parts |
| Orient Chemical Industries. Ltd.) | |
| ester wax (WEP-5, manufactured by NOF corporation) | 5 parts |
| carbon black (REGAL 330 R, manufactured by Cabot Japan | 10 parts |
| K.K.) | |

The materials of the recipe described above are preliminarily mixed by a HENSCHEL MIXER (FM10B, manufactured by MITSUI MINING COMPANY, LIMITED) and mixed and kneaded at 100° C. by a two-axis kneader (PCM-30, manufactured by Ikegai Co., Ltd.). The resulting mixture is finely-pulverized using a supersonic wave jet pulverizer (Labojet, manufactured by Nippon Pneumatic MFG. Co., Ltd.) and the resultant is classified by an air-classifier (MDS-I, manufactured by Nippon Pneumatic MFG. Co., Ltd.) to prepare mother toner particles having a number average particle diameter of 5.2 μm, a standard deviation of 1.76 of number distribution, a variation coefficient (standard deviation of number distribution/number average particle diameter) of 33.8 and toner particles having a particle diameter of from 4.0 to 8.0 μm in an amount of 51% by number. 1.5 parts of colloidal silica (R-972, manufactured by Clariant) is mixed with 100 parts of the mother toner particle by a sample mill to obtain Example Toner 7. The peak top molecular weight thereof is 2,600.

### Example Toner 8

### Recipe

| | |
|---|---|
| crystalline polyester resin PC1 | 30 parts |
| hybrid resin HB1 | 50 parts |
| zinc (III) complex of salicylic acid (E-84, manufactured by | 55 parts |
| Orient Chemical Industries. Ltd.) | |
| Ester wax (WEP-5, manufactured by NOF corporation) | 5 parts |
| Carbon black (REGAL 330 R, manufactured by Cabot Japan | 10 parts |
| K.K.) | |

The materials of the recipe described above are preliminarily mixed by a HENSCHEL MIXER (FM10B, manufactured by MITSUI MINING COMPANY, LIMITED) and mixed and kneaded at 100° C. by a two-axis kneader (PCM-30, manufactured by Ikegai Co., Ltd.). The resulting mixture is finely-pulverized using a supersonic wave jet pulverizer (Labojet, manufactured by Nippon Pneumatic MFG. Co., Ltd.) and the resultant is classified by an air-classifier (MDS-I, manufactured by Nippon Pneumatic MFG. Co., Ltd.) to prepare mother toner particles having a number average particle diameter of 4.4 μm, a standard deviation of 1.01 of number distribution, a variation coefficient (standard deviation of number distribution/number average particle diameter) of 22.9 and toner particles having a particle diameter of from 4.0 to 8.0 μm in an amount of 53% by number. 1.5 parts of colloidal silica (R-972, manufactured by Clariant) is mixed with 100 parts of the mother toner particle by a sample mill to obtain Example Toner 8. The peak top molecular weight thereof is 3,500.

### Comparative Example Toner 1

| | |
|---|---|
| Crystalline polyester resin PC2 | 15 parts |
| Hybrid resin HB1 | 55 parts |
| Non-crystalline polyester NC5 | 5 parts |
| Zirconium (III) complex of salicylic acid (X-11, manufactured | 5 parts |
| by Orient Chemical Industries. Ltd.) | |
| Ester wax (WEP-2, manufactured by NOF corporation) | 10 parts |
| Carbon black (REGAL 330 R, manufactured by Cabot Japan | 10 parts |
| K.K.) | |

The materials of the recipe described above are preliminarily mixed by a HENSCHEL MIXER (FM10B, manufactured by MITSUI MINING COMPANY, LIMITED) and mixed and kneaded at 90° C. by a two-axis kneader (PCM-30, manufactured by Ikegai Co., Ltd.). The resulting mixture is finely-pulverized using a supersonic wave jet pulverizer (Labojet, manufactured by Nippon Pneumatic MFG. Co., Ltd.) and the resultant is classified by an air-classifier (MDS-I, manufactured by Nippon Pneumatic MFG. Co., Ltd.) to prepare mother toner particles having a number average particle diameter of 3.1 μm, a standard deviation of 0.99 of number distribution, a variation coefficient (standard deviation of number distribution/number average particle diameter) of 32.0 and toner particles having a particle diameter of from 4.0 to 8.0 μm in an amount of 22% by number. 3.0 parts of colloidal silica (H-2000, manufactured by Clariant) is mixed with 100 parts of the mother toner particle by a sample mill to obtain Comparative Example Toner 1. The peak top molecular weight thereof is 2,200.

### Comparative Example Toner 2

| | |
|---|---|
| crystalline polyester resin PC1 | 30 parts |
| hybrid resin HB1 | 10 parts |
| non-crystalline polyester NC5 | 35 parts |
| zirconium (III) complex of salicylic acid (X-11, manufactured | 5 parts |
| by Orient Chemical Industries. Ltd.) | |
| ester wax (WEP-2, manufactured by NOF corporation) | 10 parts |
| carbon black (REGAL 330 R, manufactured by Cabot Japan | 10 parts |
| K.K.) | |

The materials of the recipe described above are preliminarily mixed by a HENSCHEL MIXER (FM10B, manufactured by MITSUI MINING COMPANY, LIMITED) and mixed and kneaded at 120° C. by a two-axis kneader (PCM-30, manufactured by Ikegai Co., Ltd.). The resulting mixture is finely-pulverized using a supersonic wave jet pulverizer (Labojet, manufactured by Nippon Pneumatic MFG. Co., Ltd.) and the resultant is classified by an air-classifier (MDS-I, manufactured by Nippon Pneumatic MFG. Co., Ltd.) to prepare mother toner particles having a number average particle diameter of 7.5 μm, a standard deviation of 2.72 of number distribution, a variation coefficient (standard deviation of number distribution/number average particle diameter) of 36.3 and toner particles having a particle diameter of from 4.0 to 8.0 μm in an amount of 62% by number. 2.0 parts of colloidal silica (H-2000, manufactured by Clariant) is mixed with 100 parts of the mother toner particle by a sample mill to obtain Comparative Example Toner 2. The peak top molecular weight thereof is 5,800.

### Comparative Example Toner 3

The materials of the recipe of Comparative Example 2 are preliminarily mixed by a HENSCHEL MIXER (FM10B, manufactured by MITSUI MINING COMPANY, LIMITED) and mixed and kneaded at 90° C. by a two-axis kneader (PCM-30, manufactured by Ikegai Co., Ltd.). The resulting mixture is finely-pulverized using a supersonic wave jet pulverizer (Labojet, manufactured by Nippon Pneumatic MFG. Co., Ltd.) and the resultant is classified by an air-classifier (MDS-I, manufactured by Nippon Pneumatic MFG. Co., Ltd.) to prepare mother toner particles having a number average particle diameter of 6.3 μm, a standard deviation of 2.15 of number distribution, a variation coefficient (standard deviation of number distribution/number average particle diameter) of 34.1 and toner particles having a particle diameter of from 4.0 to 8.0 μm in an amount of 52% by number. 3.0 parts of colloidal silica (H-2000, manufactured by Clariant) is mixed with 100 parts of the mother toner particle by a sample mill to obtain Comparative Example Toner 3. The peak top molecular weight thereof is 4,400. Evaluation on Examples 1 to 10 and Comparative Examples 1 to 3

### Image Evaluation Method

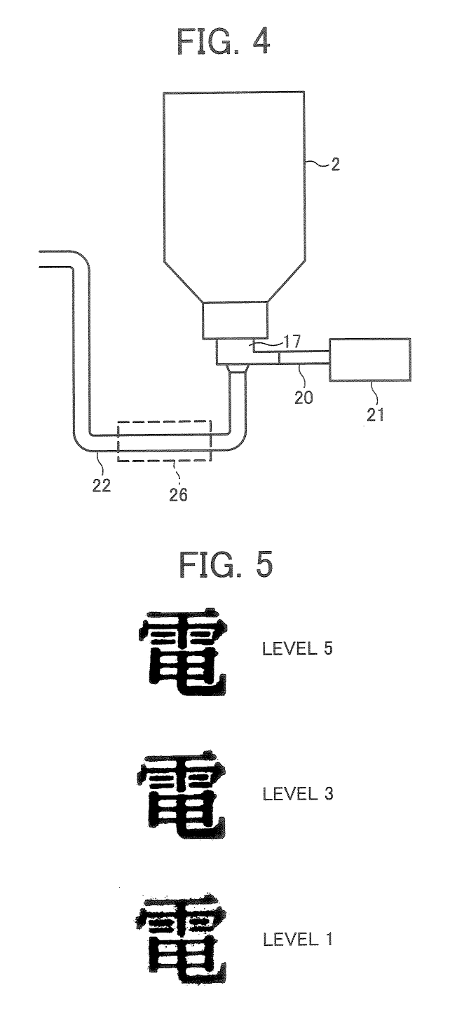

The toner supply device illustrated in FIG. 4 is used and the development portion of a photocopier (Imagio neo C385, manufactured by Ricoh Co., Ltd.) is remodeled to supply toner to the development portion. As a toner container 2 of the toner supply device, a polyethylene container having a volume reduction ratio of 70% by a vacuum pump (100 mmHg) is used and each of Toners of Examples 1 to 8 and Comparative Examples 1 to 3 are filled therein. In addition, as an air supply device of the toner supply device, an air pump 21 and a powder pump 26 having a nozzle are provided. As the powder pump 26, two kinds of powder pumps (a powder pump A in which a tube is compressed by rotary bearing to transfer toner, and a powder pump B (mohno pump)) are used. The toners are supplied under the conditions shown in Table 1 to form an image and the evaluation is made on the image by the following image evaluation method. The results are shown in Table 1. Images are formed by using a two component developing agent prepared by mixing each of the toners of Examples and Comparative Examples with a silicone coated carrier with a density of toner of 5%. The results are shown in Table 1.

Image properties are evaluated as follows: The toner container described above having a volume reduction ratio of 70% is filled with the toner and preserved at 50° C. for 24 hours; Images are formed at room temperature (25° C.) and normal humidity (60%) until the toner depletion sensor detects that the toner is empty in the container; and the weight ratio (%) of the residual toner in the container is measured.

Weight ratio of residual toner in the container=[Weight of residual toner (g)/weight of toner filled in the container (g)]×100

The supply efficiency is good when the amount of the residual toner is small.

Thereafter, the toner container preserved at room temperature (25° C.) and normal humidity (60%) is set and 100,000 prints are made followed by image evaluation.
Character sharpness: The character illustrated in FIG. 5 having a size of about 2 mm×about 2 mm is magnified with a power of about 30 and scaled according to the evaluation criteria illustrated in FIG. 5. Rank 2 and 4 are the middle level between Rank 1 and Rank 3 and between Rank 3 and Rank 5, respectively.
Image density: The density of a solid black circle having a diameter of 3 cm is measured at 10 points by a Macbeth densitometer and the average thereof is determined as the image density.
Image density non-uniformity: The density of a solid black circle image having a diameter of 3 cm is measured at 10 points by a Macbeth densitometer and the difference between the maximum and the minimum is determined as the image density non-uniformity.
Fogging: Fogging scales according to the following:
   A: no fogging
   B: slightly observed but no practical problem
   C: significantly observed

TABLE 1

| | Example 1 | Example 2 | Example 3 | Example 4 | Example 5 | Example 6 | Example 7 |
|---|---|---|---|---|---|---|---|
| Powder | A | B | B | B | B | B | B |
| pump | | | | | | | |
| Air | No | NO | Yes | Yes | Yes | Yes | Yes |
| supply | | | | | | | |
| Filled | Example | Example | Example | Example | Example | Example | Example |
| toner | toner 1 | toner 1 | toner 1 | toner 2 | toner 3 | toner 4 | toner 1 |
| Character | 5 | 5 | 5 | 5 | 4 | 4 | 5 |
| sharpness | | | | | | | |
| Image | 1.45 | 1.43 | 1.46 | 1.42 | 1.40 | 1.41 | 1.39 |
| density | | | | | | | |
| Image | 0.02 | 0.02 | 0.01 | 0.01 | 0.03 | 0.04 | 0.05 |
| density | | | | | | | |
| Non- | | | | | | | |
| uniformity | | | | | | | |
| Fogging | A | A | A | A | B | A | B |
| Weight | 7 | 4 | 3 | 3 | 2 | 3 | 5 |
| ratio of | | | | | | | |
| remaining | | | | | | | |
| toner (%) | | | | | | | |

| | | | Example | Comparative | Comparative | Comparative |
|---|---|---|---|---|---|---|
| | Example 8 | Example 9 | 10 | Example 1 | Example 2 | Example 3 |
| Powder | B | B | B | B | B | B |
| pump | | | | | | |
| Air | Yes | Yes | Yes | Yes | Yes | Yes |
| supply | | | | | | |
| Filled | Example | Example | Example | Comparative | Comparative | Comparative |
| toner | toner 1 | toner 1 | toner 1 | Example | Example | Example |
| | | | | Toner 1 | Toner 2 | Toner 3 |
| Character | 5 | 4 | 4 | 3 | 2 | 3 |
| sharpness | | | | | | |
| Image | 1.42 | 1.38 | 1.37 | 1.22 | 1.20 | 1.26 |
| density | | | | | | |
| Image | 0.05 | 0.03 | 0.06 | 0.28 | 0.25 | 0.17 |
| density | | | | | | |
| Non- | | | | | | |
| uniformity | | | | | | |
| Fogging | B | B | B | C | C | B |
| Weight | 6 | 3 | 3 | 6 | 22 | 16 |
| ratio of | | | | | | |
| remaining | | | | | | |
| toner (%) | | | | | | |

In Table 1, Toner of Examples represents Example Toner, i.e., toner of the present invention. Toner of Comparative Examples represents Comparative Example Toner, toner for use in comparison with the toner of the present invention. Air supply represents whether or not air pump 21 is used.

As seen in Table 1, with regard to the toner of the present invention, characteristic sharpness (scaled as 5 in Examples 1 to 4, 7 and 8 and scaled as 4 in Examples 5, 6, 9 and 10 while scaled as 3 or less in Comparative Examples), image density (1.37 to 1.39 in Examples 7, 9 and 10 and 1.40 or higher in other Examples while less than 1.3 in Comparative Examples), image density non-uniformity (0.06 or less for Examples 1 to 10, especially 0.02 in Examples 1 and 2 and 0.1 in Examples 3 and 4 while greater than 0.1 in Comparative Examples), and fogging (especially Examples 1 to 4 and 6 are excellent) are excellent. In addition, according to the method of supplying toner of the present invention, the amount of residual toner decreases and the toner is stably supplied (especially in Examples 3 to 6, 9 and 10).

As described above, the toner of the present invention can contribute to improvement on character sharpness, image density, image density non-uniformity, fogging and reduction of the amount of residual toner. Especially, Examples 1 to 10 are good and especially Examples 1 to 4, 7 and 8 are excellent. In terms of image density, Examples 1 to 10, preferably Examples 1 to 6 and 8, more preferably Examples 1 to 4, 6 and 8 and particularly preferably Examples 1 to 3 are good. In terms of image density non-uniformity, Examples 1 to 10, preferably Examples 1 to 6 and 8, and particularly preferably Examples 1 to 4 are good. In terms of fogging, Examples 1 to 10, preferably Examples 2 to 7, 9 and 10, more preferably Examples 2 to 6, 9 and 10 and particularly preferably Examples 3 to 6, 9 and 10 are good. In the toners which are excellent about the five characteristics, the toners excellent about at least 2 characteristics among the five characteristics can be selected as a good toner. For example, in light of three characteristics, reducing the amount of residual toner, i.e., efficient contribution in the method using a size reducible container and when the method is used, fogging and image density non-uniformity, preferably the toners of Examples 2 to 7, 9 and 10 and more preferably the toners of Examples 2 to 7 and 9 can be selected because these toners have the three characteristics in good balance.

In addition, when the image density, fogging, characteristic sharpness and image density are selected while the amount of residual toner is not taken into consideration, the toners of Examples 1 to 10, preferably the toners of Examples 1 to 6, 9 and 10, and more preferably the toners of Examples 1 to 6 and 9 can be selected. Namely, in the present invention, the toner can be suitably selected in combination depending on the purposes and such toners are in the scope of the present invention.

This document claims priority and contains subject matter related to Japanese Patent Application No. 2006-298194 filed on Nov. 1, 2007, the entire contents of which are incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. A toner comprising:
a colorant;
a binder resin; and
a releasing agent,
wherein the toner has a number average particle diameter measured by a Coulter Counter method of from 3.5 to 6.5 μm and a peak top molecular weight (MPT) of from 2,500 to 4,800, the binder resin comprises a crystalline polyester resin and a hybrid resin component comprising a styrene-acryl resin and a polyester resin, wherein a content A of the crystalline polyester resin and a content B of the hybrid resin component satisfy the following relationship (1): ½ A≦B≦3 A, and the crystalline polyester resin has a structure represented by chemical formula (A) having at least 60 mol % of whole ester bonds in the binder resin:
—OOC—R—COO—(CH₂)ₙ—, (A)
wherein R represents a straight chain unsaturated aliphatic group having 2 to 20 carbon atoms and n represents an integer of from 2 to 20.

2. The toner according to claim 1, wherein the binder resin further comprises a non-crystalline polyester resin.

3. The toner according to claim 2, wherein the non-crystalline polyester resin has a softening point of from 120 to 160° C.

4. The toner according to claim 2, wherein the non-crystalline polyester resin satisfies the following relationship (2):
0.008≦G′(0.01 Hz)/G′(1 Hz)≦0.90 (2)
wherein G′ (1 Hz) and G′ (0.01 Hz) represents a storage elastic modulus of the non-crystalline polyester resin at a frequency of 1 Hz and 0.01 Hz, respectively, by a frequency sweep method using a rheometer.

5. The toner according to claim 1, wherein at least one compound selected from the group consisting of an inorganic tin(II)compound, a tin(II)carbonate compound having a carboxyl acid group having 2 to 28 carbon atoms and a dialkoxy tin(II)compound having an alkoxy group having 2 to 28 carbon atoms is used as a catalyst when the crystalline polyester is manufactured.

6. The toner according to claim 1, wherein at least one compound selected from the group consisting of an inorganic tin(II)compound, a tin(II)carbonate compound having a carboxyl acid group having 2 to 28 carbon atoms and a dialkoxy tin(II)compound having an alkoxy group having 2 to 28 carbon atoms is used as a catalyst when the hybrid resin is manufactured.

7. The toner according to claim 2, wherein at least one compound selected from the group consisting of an inorganic tin(II)compound, a tin(II)carbonate compound having a carboxyl acid group having 2 to 28 carbon atoms and a dialkoxy tin(II)compound having an alkoxy group having 2 to 28 carbon atoms is used as a catalyst when the non-crystalline polyester resin is manufactured.

8. The toner according to claim 2, wherein at least one compound selected from the group consisting of an inorganic tin(II)compound, a tin(II)carbonate compound having a carboxyl acid group having 2 to 28 carbon atoms and a dialkoxy tin(II)compound having an alkoxy group having 2 to 28 carbon atoms is used as a catalyst when the crystalline polyester, the hybrid resin and the non-crystalline polyester resin are manufactured.

9. The toner according to claim 1, wherein a particles distribution variance coefficient (standard deviation of number of particles distribution/number average particle diameter×100) of the toner measured by the COULTER COUNTER method is from 22.0 to 35.0 and the toner comprises toner particles having a particle diameter of from 4.0 to 8.0 μm in an amount of from 40 to 59% by number.

10. A method of supplying toner comprising:
transferring a fluid mixture of powder of the toner of claim 1, accommodated in a toner container, and air to a development portion of electrophotographic recording medium or apparatus by a pumping device by which backflow of the fluid mixture is prevented.

11. The method of supplying toner according to claim 10, wherein an air influx device configured to flow air in the toner container is provided.

12. The method of supplying toner according to claim 10, wherein the toner container comprises a flexible member and has a volume contraction ratio of not less than 60% in volume.

13. The method of supplying toner according to claim 10, wherein the pumping device is provided such that backflow of the fluid mixture of toner powder and air is prevented by rotating a fixed hollow elastic member and a spirally curved rigid axis contacting an inner wall of the fixed hollow elastic member.

14. A process cartridge comprising:
an image bearing member;
a development device; and
at least one of a charge device and a cleaning device,
wherein the process cartridge is detachably attached to a main body of an image forming apparatus and the development device contains therein the toner of claim 1.
